(19) United States
(12) Patent Application Publication
(10) Pub. No.: US 2024/0387101 A1
(43) Pub. Date: Nov. 21, 2024

(54) Ballistic Cape and Array System and Method Using Indexed Column Vector

(71) Applicant: Robert Velasco, Gilbert, AZ (US)

(72) Inventor: Robert Velasco, Gilbert, AZ (US)

(21) Appl. No.: 18/664,003

(22) Filed: May 14, 2024

Related U.S. Application Data
(60) Provisional application No. 63/503,223, filed on May 19, 2023.

(51) Int. Cl. H01F 27/40; F41H 5/013; F41H 5/24

(52) U.S. Cl. CPC H01F 27/402; F41H 5/013; F41H 5/24

(57) ABSTRACT

A ballistic panel has a ballistic material and a fastening mechanism adapted to dispose the ballistic material with standoff over a surface of an asset. The asset can be a power transformer and more specifically the cooling system of the power transformer. The fastening mechanical can have a rail coupled to the asset. A standoff is coupled to the rail, and a bracket is coupled between the standoff and ballistic material. The standoff creates separation between the ballistic panel and asset. The ballistic material can have a first layer and a second layer bonded to the first layer. The first layer can be polyethylene, aramid fiber, ballistic fabric, adhesives, ceramics, and aluminum oxide. The second layer can be steel, galvanized steel, iron, aluminum, and other metal having structural support for the first layer. A plurality of overlapping ballistic panels can be disposed over the surface of the asset.

### CLAIM OF DOMESTIC PRIORITY

The present application claims the benefit of U.S. Provisional Application No. 63/503,223, filed May 19, 2023, which application is incorporated herein by reference.

### FIELD OF THE INVENTION

The present invention relates in general to a ballistic protection system and, more particularly, to a ballistic cape and array system and method using an indexed column vector.

### BACKGROUND

Electric power generation and distribution is an integral and necessary part of modern society. Electric power is used in virtually every aspect of daily life. Electric power is typically generated at a power plant, such as hydro-power, fossil fuel, nuclear, wind, or other renewable energy source. The power generation source can be operated by a utility company, government agency, or private entity. The electric power is transmitted and distributed through a power grid, often over long distances (e.g., hundreds of miles) to industries, commercial businesses, government, and residential users. FIG. 1 illustrates a power grid 10 providing electric power from power generation source 12, through transmission and distribution lines 14, to end-user 16. The voltage of the electrical power varies over power grid 10. At power generation source 12, the voltage may start at 30,000 volts (30 KV). The voltage is methodically stepped up, to say 500 KV for transmission, and then stepped down at strategic points in power grid 10, such as distribution substations, until reaching end-user 16. End-user 16 typically receives 240 volts.

The step-up and step-down in voltage is performed with a power transformer, typically located at the substation. FIG. 2 illustrates an electrical schematic of conventional power transformer 20 including a first coil 22 with a first number of windings or turns and a second coil 24, adjacent to the first coil 22, with a second number of windings or turns, different from the first number of windings or turns. The ratio between the first number of windings and the second number of windings determines the step-up or step-down in voltage. The voltage V_{IN} is transformed into voltage V_{OUT} by the ratio of turns between coil 22 and coil 24. Given the high voltages in power grid 10, transformer 20 can generate high thermal energy in the form of excessive heat. Transformer 20 must be cooled in such applications. That is, transformer 20 must use some type of cooling system, such as a radiator, to dissipate excessive thermal energy. Otherwise, transformer 20 will over-heat and fail, causing significant or even catastrophic disruption to power grid 10.

FIG. 3 shows further detail of transformer 20 with cooling system 30. The input voltage V_{IN} is coupled to terminals or bushings 32 and the stepped up (or stepped down) output voltage V_{OUT} is taken at terminals or bushings 34. Coils 22 and 24 are internal to transformer 20 in FIG. 3. Cooling system 30 circulates cooling fluid, typically an oil, through conduits in proximity to and around coils 22 and 24 to remove excessive thermal energy generated by the voltage transformation. The cooling fluid is routed from the conduits in proximity to coils 22 and 24 through radiator fins 38 to dissipate the thermal energy generated by the coils to the external environment. The system works well in power grid 10 to perform the essential function of efficient and reliable delivery of electrical power to end-user 16. Any disruption to power grid 10 can present significant issues to all concerned.

Unfortunately, domestic terrorism and other adverse factors are a significant problem in any country. There are people and organizations that would seek to cause problems within a country for their own agenda, be it for political, personal, or financial gain. One way to achieve that goal is to disrupt power grid 10, and one way to disrupt the power grid is to disable cooling system 30 of transformer 20. Without a functional cooling system 30, transformer 20 would quickly over-heat and fail. Depending on the position of transformer 20 within power grid 10, major portions of the power grid, i.e., a large number of end-users 16, could be without electric power. In modern society, end-users 16 cannot perform most daily functions with no electric power. Communications are down, lights are out, transportation is non-functional or adversely affected, direct electric-powered devices cannot operate, and so on. The terrorists would have achieved their goal, to shutdown at least a portion of the country, and thus advance their own interests.

Taking out transformer 20 can be achieved in a variety of ways. In one example, terrorist 40 can take position some distance away from transformer 20 and shoot bullets into radiator fins 38 with firearm 42, as shown in FIG. 4. The bullets would penetrate radiator fins 38 allowing the cooling fluid to leak out, resulting in failure of cooling system 30 and ultimately transformer 20.

One solution has been to build a protective structure around transformer 20. The protective structure is typically a wall 46 constructed around power transformer 20, as shown in FIG. 5. Wall 46 can be concrete, steel, or other metal, and must be firmly set into a foundation with footings and posts to support the vertical wall for strength and durability. Walls 46 are heavy and therefore must be constructed separate from transformer 20, i.e., the asset, and cannot be directly attached to or even close to the overall assembly to avoid suppressing and restraining airflow necessary for the cooling of the asset. Wall 46 is typically located 4.0-6.0 meters from power transformer 20 to avoid interfering with its cooling operation. Wall 46 is a relatively major undertaking to build, involving manpower and materials, and consuming time and cost. Wall 46 can be effective for attacks from ground level. However, wall 46 is relatively easy to overcome as terrorist 40 simply moves to higher ground to get a line-of-sight angle over wall 46 to power transformer 20. The higher ground can take the form of a nearby building or hill. The higher ground can also be in flight from airplane, helicopter, ultra-light aircraft, balloon, or the like. The higher ground can also be achieved with a remote-controlled drone. In any case, wall 46 is time consuming and costly to build and relatively easy to overcome in its intended function or purpose.

### BRIEF DESCRIPTION OF THE DRAWINGS

FIG. 1 illustrates power grid with power generation source, power transmission and distribution, and end-user;

FIG. 2 illustrates an electrical schematic of a conventional power transformer;

FIG. 3 illustrates the power transformer with a cooling system;

FIG. 4 illustrates an attack on the cooling system of the power transformer;

FIG. 5 illustrates a wall intended to negate an attack on the cooling system of the power transformer;

FIG. 6 illustrates ballistic panels disposed over radiator fins of a power transformer;

FIG. 7 illustrates an electrical schematic of the coils of the power transformer;

FIG. 8 illustrates further detail of the power transformer cooling system with ballistic panels covering the radiator fins;

FIG. 9 illustrates a perspective view of ballistic material for the ballistic panel;

FIG. 10 illustrates a side view of the ballistic material for the ballistic panel;

FIG. 11 illustrates a perspective view of a ballistic panel;

FIG. 12 illustrates a top side view of ballistic panels attached to the radiator fins with standoff;

FIG. 13 illustrates further detail of the ballistic panels attached to the radiator fins from FIG. 12;

FIG. 14 illustrates a top view of ballistic panels attached to the radiator fins with standoff;

FIG. 15 illustrates a bottom side view ballistic panels attached to the radiator fins with standoff;

FIG. 16 illustrates further detail of the ballistic panels attached to the radiator fins from FIG. 15;

FIG. 17 illustrates a side view of the ballistic material for the ballistic panel with mosaic ceramic film;

FIG. 18 illustrates a perspective view of ballistic material formed on the radiator fins;

FIGS. 19a-19b illustrate ballistic material formed on the radiator fins with angled side ballistic panels;

FIGS. 20a-20b illustrate ballistic panels disposed over the radiator fins with angled side ballistic panels;

FIG. 21 illustrates a simplified view of stacked ballistic capes disposed over the radiator fins;

FIG. 22 illustrates a simplified view of stacked ballistic capes disposed over the radiator fins with angled and stacked side ballistic panels;

FIG. 23 illustrates a simplified view of full-length ballistic capes disposed over the radiator fins;

FIG. 24 illustrates a simplified view of full-length ballistic capes disposed over the radiator fins with full-length and angled side ballistic panels;

FIG. 25 illustrates a simplified view of ballistic capes disposed over an entirety of the radiator fins;

FIG. 26 illustrates a simplified view of ballistic capes disposed over an entirety of the power transformer;

FIG. 27 illustrates a ballistic cape disposed over load tap changers 160;

FIG. 28 illustrates ballistic capes disposed over a tank, bushings, and breaker boxes;

FIG. 29 illustrates a ballistic cape disposed over other vulnerable equipment;

FIG. 30 illustrates stacked ballistic capes disposed over a mobile transport;

FIG. 31 illustrates ballistic capes attached to posts to form a ballistic screen; and

FIG. 32 illustrates ballistic capes attached to posts to form another ballistic screen.

### DETAILED DESCRIPTION OF THE DRAWINGS

The following describes one or more embodiments with reference to the figures, in which like numerals represent the same or similar elements. While the figures are described in terms of the best mode for achieving certain objectives, the description is intended to cover alternatives, modifications, and equivalents as may be included within the spirit and scope of the disclosure.

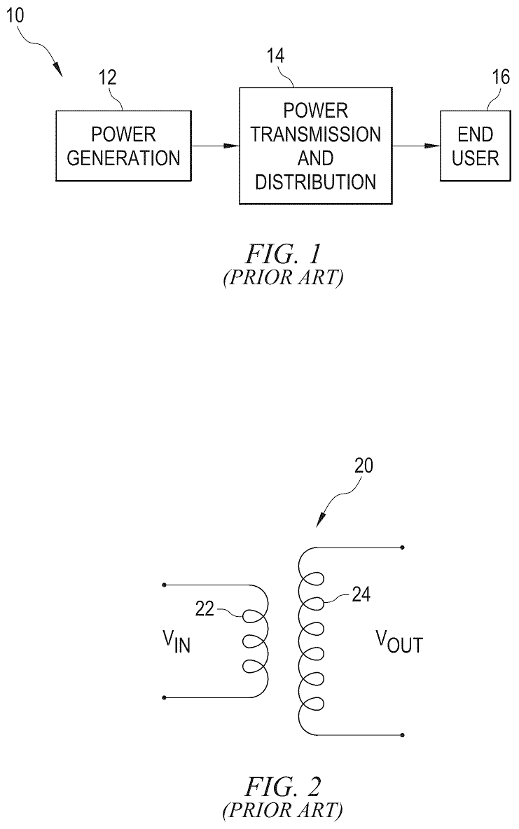

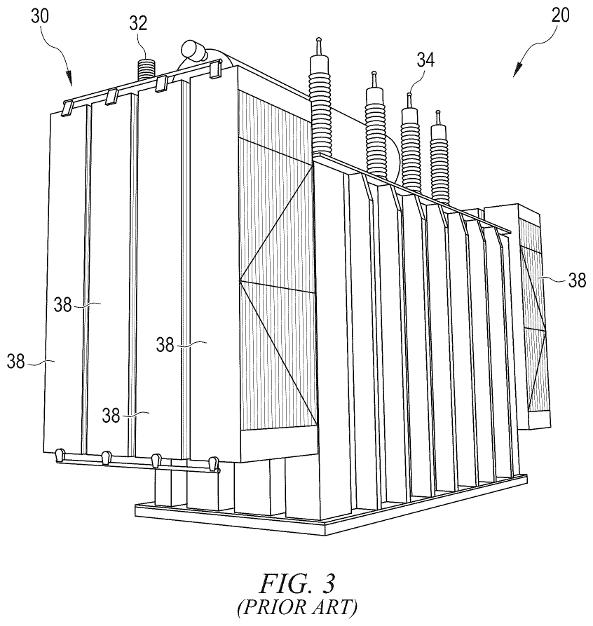

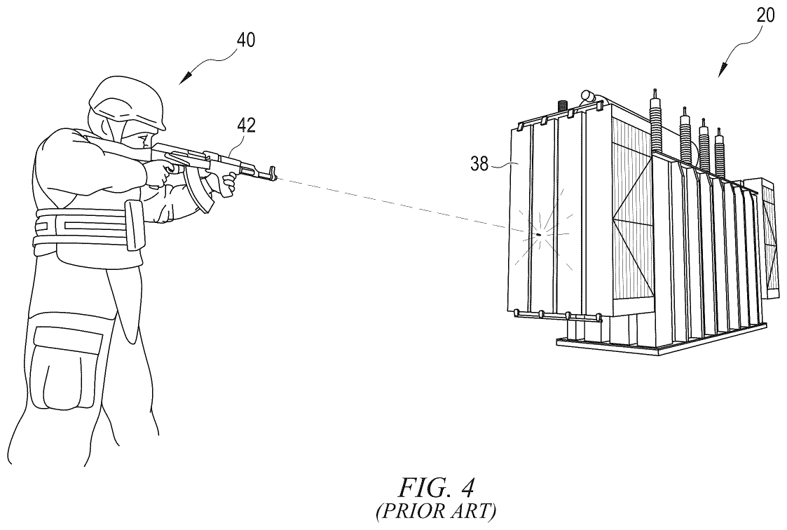

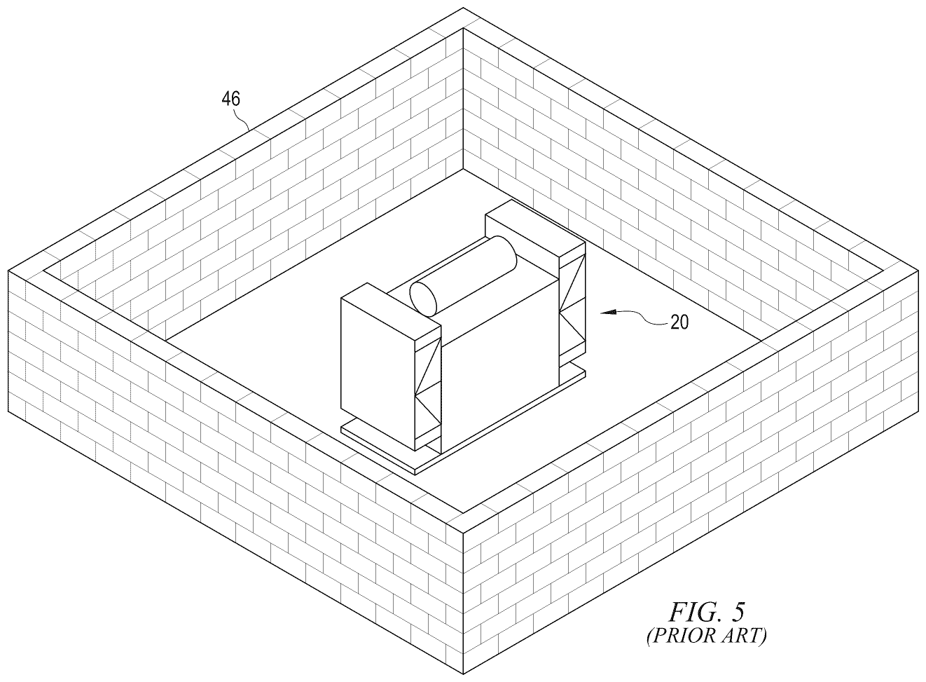

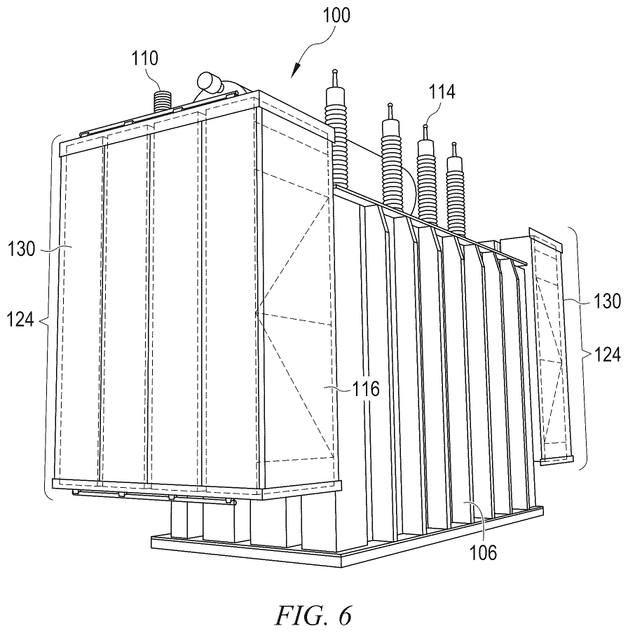

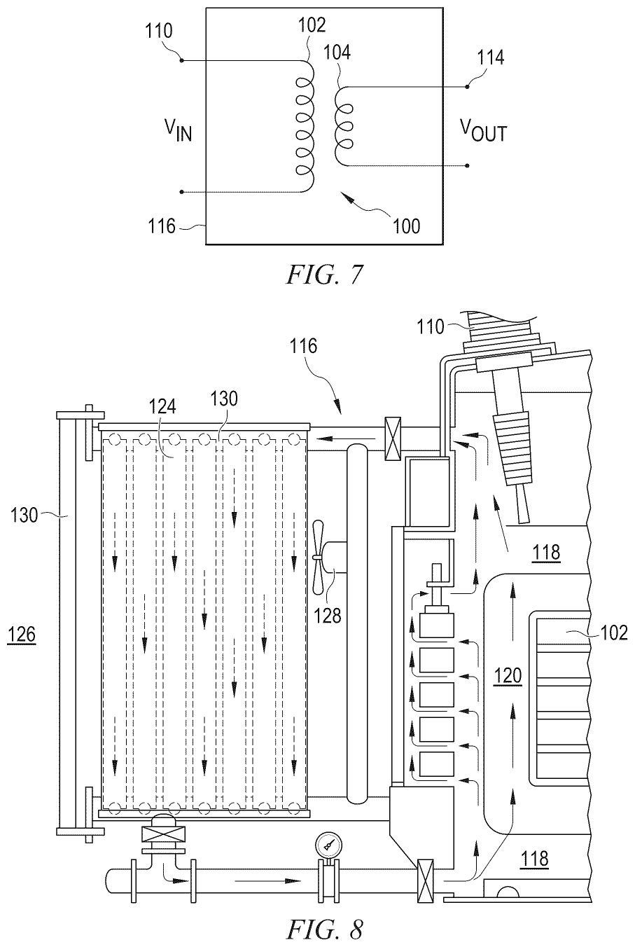

FIG. 6 illustrates power transformer 100 for use in a power grid, such as described in FIG. 1. Power transformer 100 can be found in a power generation facility, transmission substation, and/or distribution substation. Power transformer 100 has coils 102 and 104 with windings or turns within main structure 106 to perform the voltage transformation, i.e., either step-up or step-down. FIG. 7 is an electrical schematic of coils 102 and 104 within power transformer 100. The input voltage V_{IN} is applied to terminals or bushings 110 and the output voltage _{VOUT} is taken at terminals or bushings 114. In one embodiment, the input voltage V_{IN} may be stepped down from 275 KV (transmission network voltage level) to an output voltage V_{OUT} of 34 KV (distribution network voltage level). The voltage transformation within power transformer 100 generates significant thermal energy.

Power transformer 100 includes cooling system 116 to circulate cooling fluid, typically an oil, through conduits in proximity around internal coils 102 and 104 to remove excessive thermal energy generated by the voltage transformation. FIG. 8 shows further detail of cooling system 116, including conduits 118 circulating cooling fluid 120 in proximity to coils 102 and 104. The heat from coils 102 and 104 is transferred to cooling fluid 120 which then flows through radiator fins 124 to dissipate the thermal energy generated by the coils to the external environment 126. Fan 128 aids with dissipating the thermal energy generated by coils 102 and 104 to the external environment 126.

An asset can be power transformer 100, in whole or any portion thereof, as well as other electrical equipment and systems necessary to the control and operation of the power grid. To protect power transformer 100 and other critical assets from external threats of sabotage, such as described in the background, ballistic material 130 is mounted in proximity to and around radiator fins 124. Each radiator fin 124 may be 0.6 meters (m) wide and 2.5 m high. Ballistic material 130 is mounted to one or more side surfaces of radiator fins 124, as well as to the otherwise exposed top surface of the radiator fins. Ballistic material 130 shrouds radiator fins 124 as a ballistic cape designed to provide enhanced protection against ballistic threats while maintaining structural and functional integrity and ease of installation. Ballistic material 130 has a ballistic rating of Underwriters Laboratory (UL)-752 level 8 or National Institute of Justice (NIJ) type III and will stop bullets, projectiles, and other ballistic threats from damaging radiator fins 124, that would otherwise disable or destroy power transformer 100. In one embodiment, ballistic material 130 will stop a 7.62 millimeter (mm) lead core full metal copper jacket round. Higher ballistic ratings can be achieved with ballistic material 130.

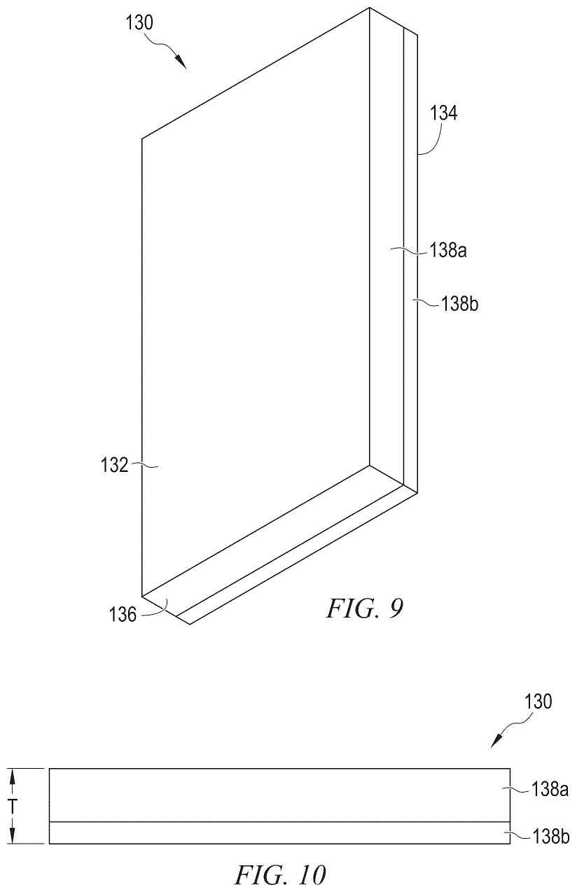

FIG. 9 illustrates further detail of ballistic material 130. Ballistic material 130 has first major surface 132 and second major surface 134, opposite surface 132, and side surfaces 136. Ballistic material 130 is made with a combination of materials and design features that improve its resistance to penetration and minimize the risk of catastrophic failure of critical assets required to operate critical infrastructure, including electrical substations and power generation facilities. Ballistic material 130 can be one homogenous layer, or a plurality of layers bonded together. For example, ballistic material 130 is shown with layer 138a and layer 138b in FIGS. 9-10. Layer 138b is bonded to layer 138a with an adhesive or by application of heat. Layer 138a is made of a lightweight ballistic composite material or chemical compound with high impact resistance properties designed to absorb and dissipate the energy generated upon impact and can consist of a combination of materials or chemical compounds, such as ultra high molecular weight polyethylene, ballistic fabric, adhesives, ceramics, aluminum oxide, or other materials or chemical compounds with high energy-absorbing characteristics. In one embodiment, layer 138a is ultra high molecular weight polyethylene or an aramid fiber, such as Kevlar. In particular, layer 138a is strategically positioned to absorb and dissipate the kinetic energy of incoming projectiles, reducing their penetration potential. Layer 138b is made of steel, galvanized steel, iron, aluminum, or other metal or suitable material for additional structural support. Layer 138b is suitable for mating with fastening mechanisms and support structures, such as bracket 148, to ensure stability and durability for efficient installation, maintenance, and potential reconfiguration of the ballistic cape. Ballistic material 130 has a weight of 18 kg/m². The thickness T of ballistic material 130 is 1.72±0.23 centimeters (cm).

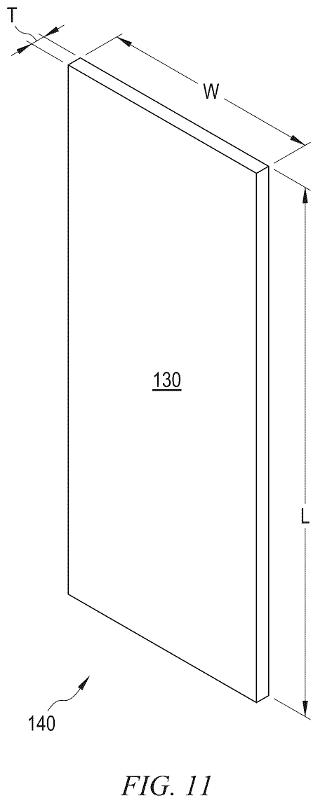

Ballistic material 130 can be formed into ballistic sheets or panels of substantially any length and width. In one embodiment, ballistic panel 140 of ballistic material 130 can be 1.5 m in length L, 0.3 m in width W, and 1.72 cm in thickness T, as shown in FIG. 11. In another embodiment, ballistic panel 140 of ballistic material 130 can be 1.5 m in length L, 1.5 m in width W, and 1.72 cm in thickness T. The size and shape of ballistic panel 140 is selectable based on the intended application.

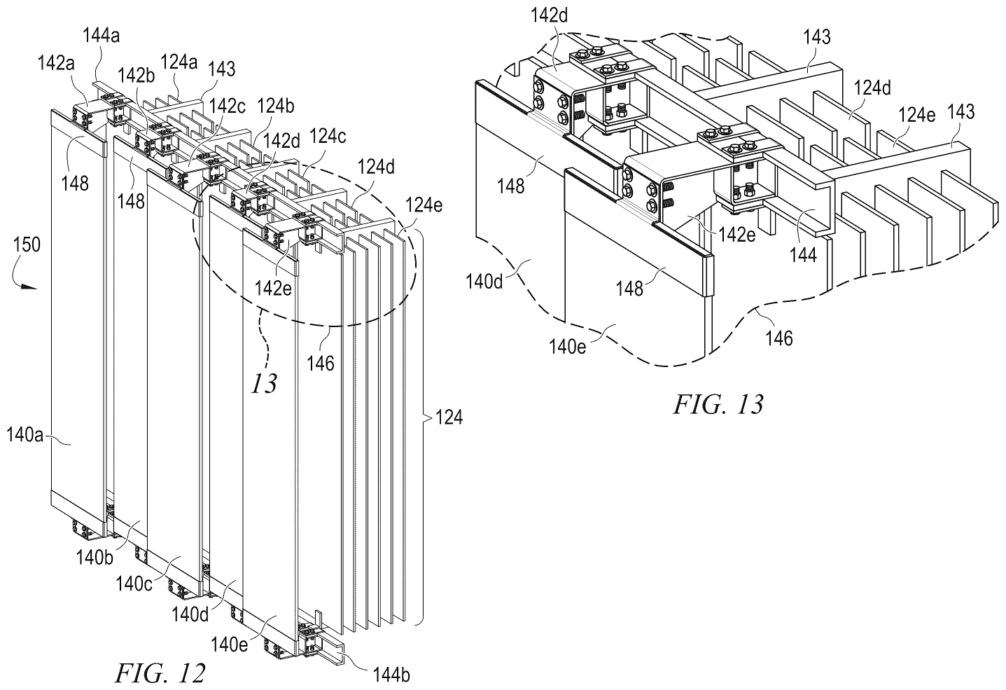

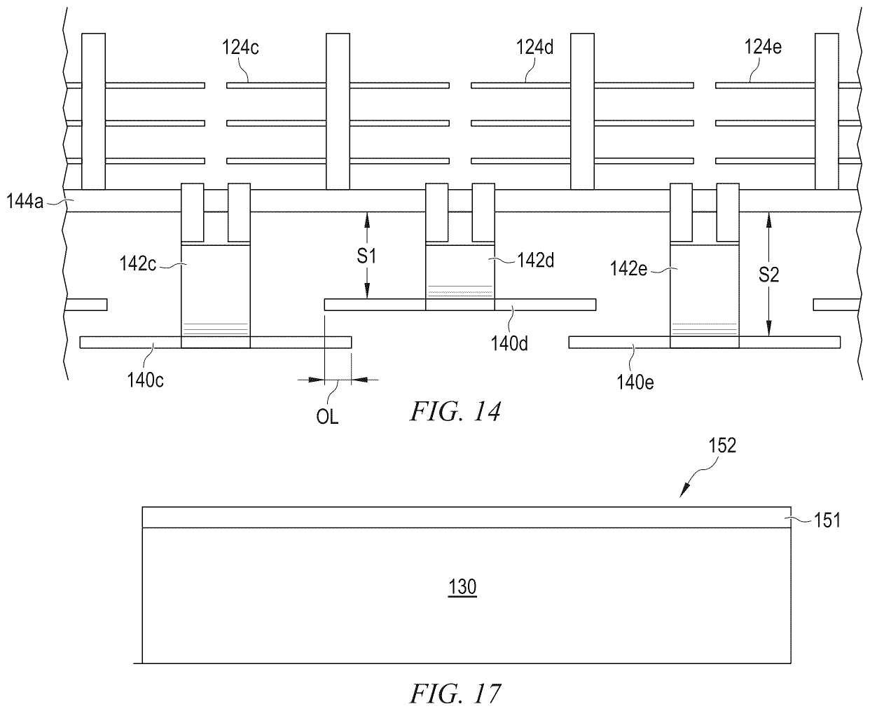

FIG. 12 illustrates ballistic panels 140 of ballistic material 130 attached to banks of radiator fins 124 to form a ballistic cape. Ballistic panel 140a is mounted using bracket 142a with standoff S2 from radiator fins 124a, see FIG. 14. Ballistic panel 140b is mounted using bracket 142b with standoff S1 from radiator fins 124b, see FIG. 14. Ballistic panel 140c is mounted using bracket 142c with standoff S2 from radiator fins 124c. Ballistic panel 140d is mounted using bracket 142d with standoff S1 from radiator fins 124d. Ballistic panel 140e is mounted using bracket 142e with standoff S2 from radiator fins 124e. Standoffs 142a-142e attach to rails 144a-144b with screws, bolts, adhesive, or weld. Brackets 148 wrap around ballistic panels 140a-140e and attach to standoffs 142a-142e with screws, bolts, adhesive, or weld. Standoffs 142, rail 144, and bracket 148 is one type of fastening mechanism to mount ballistic panel 140 to radiator fins 124. Alternatively, ballistic panel 140 is attached to radiator fins 124 using beams, frames, bolts, screws, welding joints, brackets, and anchors.

FIG. 13 illustrates further detail of area 146 showing rail 144a, ballistic panels 140d and 140e, standoffs 142d and 142e, and brackets 148. In particular, ballistic panel 140d is mounted using bracket 142d with standoff S1 from radiator fins 124d, and ballistic panel 140e is mounted using bracket 142e with standoff S2 from radiator fins 124e. Standoffs 142a-142e attach to rails 144a-144b with screws, bolts, adhesive, or weld. Brackets 148 wrap around ballistic panels 140a-140e and attach to standoffs 142a-142e with screws, bolts, adhesive, or weld.

FIG. 14 illustrates a top view of rail 144a, ballistic panels 140c-140e, and standoffs 142c-140e. There is a 5.0 cm overlap OL between adjacent ballistic panels 140c and 140d and likewise 5.0 cm OL between adjacent ballistic panels 140d and 140e to avoid a penetrating projectile between adjacent panels. Ballistic panel 140d has a standoff S1 of 30 cm from radiator fins 124d and ballistic panel 140e has a standoff S2 of 20 cm from radiator fins 124e. The standoffs S1 and S2 are important as ballistic material 130 typically deforms, indents, or bulges inward upon ballistic impact, commonly known as back-face deformation. The back-face deformation may reach 7-8 cm. The standoffs S1 and S2 are at least enough to account for the back-face deformation without impacting radiator fins 124.

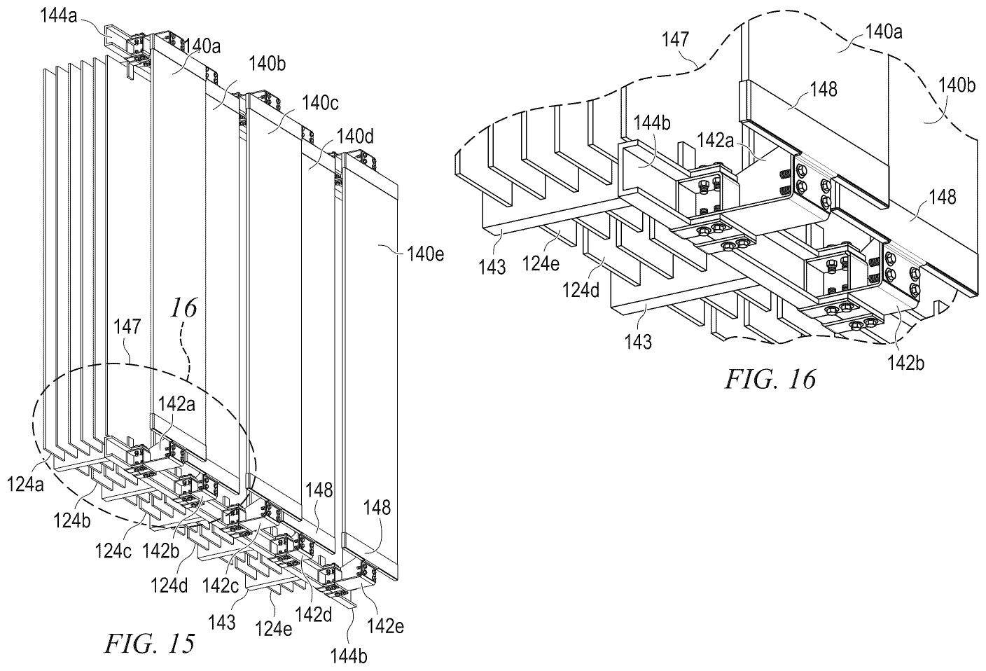

FIG. 15 shows standoff 142a-142e connections to rail 144b. Again, ballistic panels 140a-140e are mounted using brackets 142a-14e with standoff from radiator fins 124a-124e. Standoffs 142a-142e attach to rails 144b with screws, bolts, adhesive, or weld. Brackets 148 wrap around ballistic panels 140a-140e and attach to standoffs 142a-142e with screws, bolts, adhesive, or weld.

FIG. 16 illustrates further detail area 147 from FIG. 14 showing rail 144b, ballistic panels 140a-140c, standoffs 142a-142c, and brackets 148, similar to FIG. 13. Ballistic panels 140a-140e overall form ballistic cape 150 operating as an indexed column vector providing protection of radiator fins 124 from external bullets, projectiles, and other ballistic threats. Standoffs 142 and rails 144 provide a rapid and straightforward installation of the ballistic cape, reducing the time and effort required for deployment, care, and maintenance of pieces of the cape.

In another embodiment, a mosaic ceramic film 151 is applied to surface 134 of ballistic material 130 to reduce back-face deformation and achieve UL-752 level 9 of ballistic protection, as shown in FIG. 17. The combination of ballistic material 130 with mosaic ceramic film 151 is referred to as ballistic material 152.

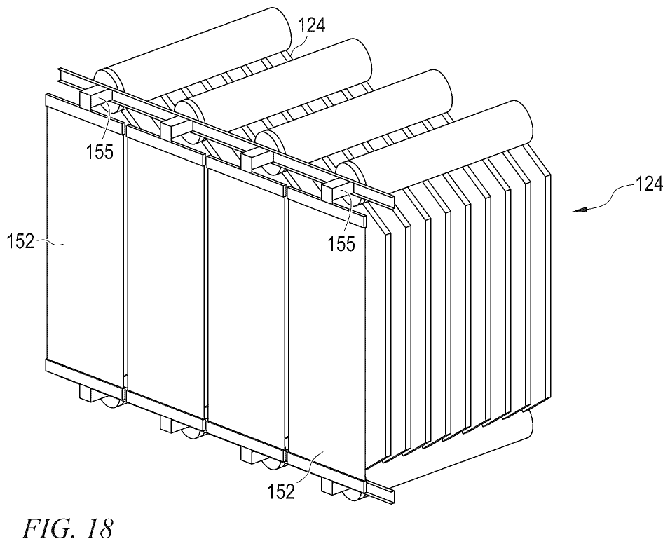

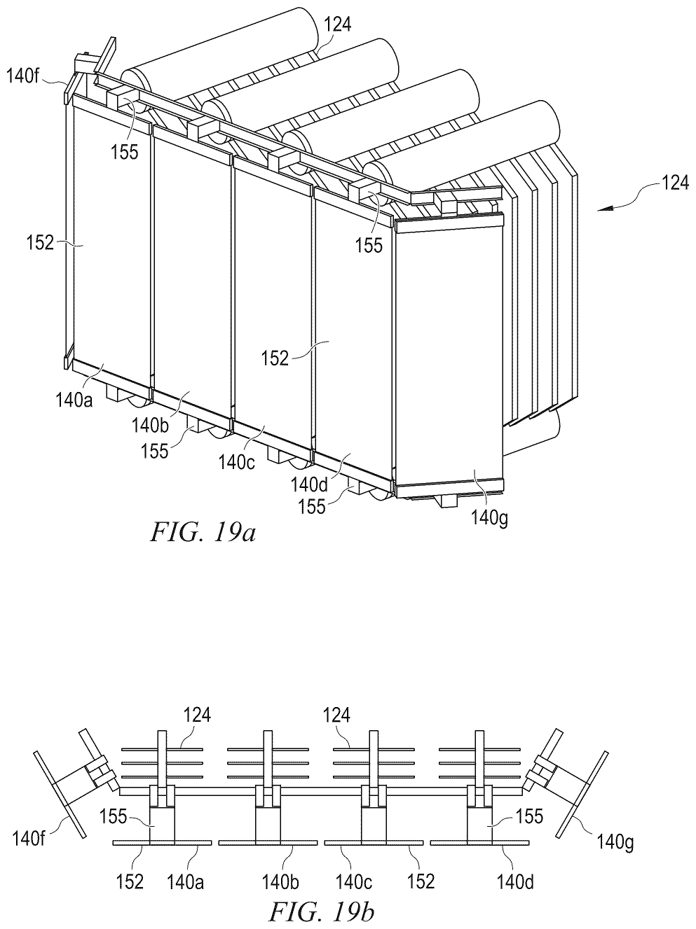

With a reduction in back-face deformation, ballistic material 130 can be disposed closer to radiator fins 124 without damaging the radiator during ballistic impact. FIG. 18 shows radiator fins 124 covered by ballistic material 152. In one embodiment, ballistic material 152 is an integral part of the manufacture of radiator fins 124, at least the outer ones. Ballistic material 152 can be sprayed on radiator fins 124. Ballistic material 152 can be hung over radiator fins 124 with spacers 155 creating a smaller gap between the ballistic material and radiator fins. FIG. 19a shows an embodiment with ballistic material 152 disposed over radiator fins 124 and ballistic panels 140f and 140g angled up to 90° to protect side surfaces of the radiator fins. FIG. 19b is a top view of ballistic material 152 disposed over radiator fins 124 and ballistic panels 140f and 140g angled to protect side surfaces of the radiator fins.

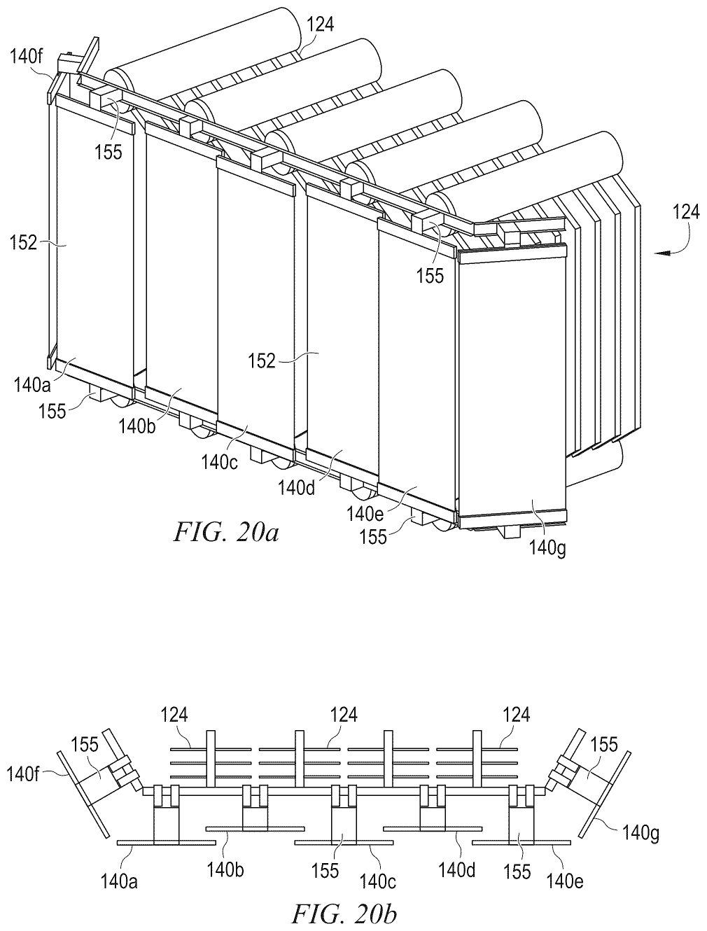

FIG. 20a shows an embodiment with ballistic panels 140a-140e positioned away from radiator fins 124a-124e and ballistic panels 140f and 140g angled up to 90° to protect side surfaces of the radiator fins. FIG. 20b is a top view of ballistic material 152 disposed over radiator fins 124 and ballistic panels 140f and 140g angled to protect side surfaces of the radiator fins.

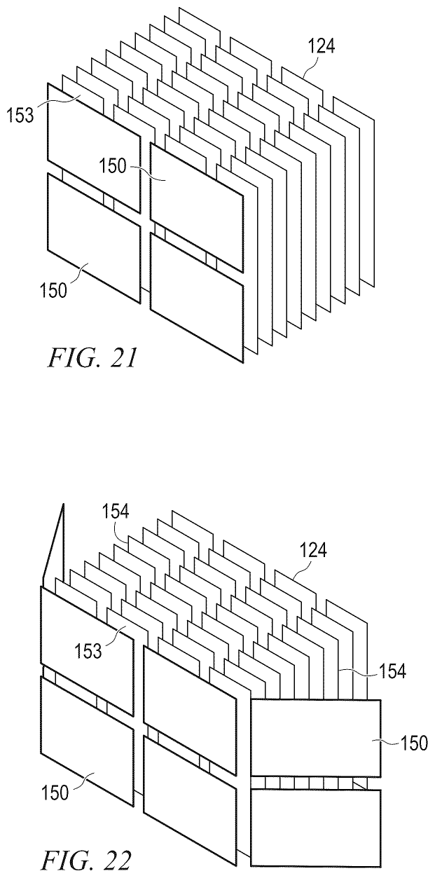

FIG. 21 illustrates a simplified view of stacked ballistic capes 150, each comprising a number of ballistic panels 140, can cover front surface 153 of radiator fins 124. The attachment mechanism could be as described in FIGS. 12-16, 18, 19a-19b, and 20a-20b.

FIG. 22 illustrates a simplified view of stacked ballistic capes 150 that can cover front surface 153 of radiator fins 124. Additional angled and stacked ballistic capes 150 at least partially cover side surfaces 154 of radiator fins 124. The attachment mechanism could be as described in FIGS. 12-16, 18, 19a-19b, and 20a-20b.

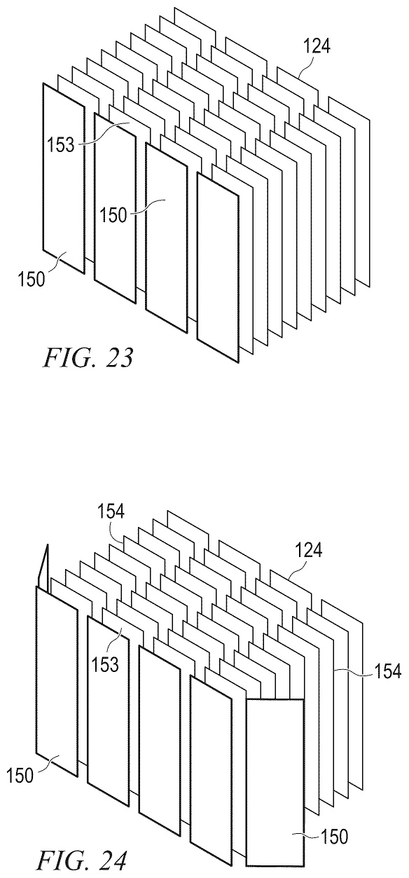

FIG. 23 illustrates a simplified view of full-length ballistic capes 150, comprising a number of ballistic panels 140, that can cover front surface 153 of radiator fins 124. The attachment mechanism could be as described in FIGS. 12-16, 18, 19a-19b, and 20a-20b.

FIG. 24 illustrates a simplified view of full-length ballistic capes 150 that can cover front surface 153 of radiator fins 124. Additional full-length and angled ballistic capes 150 at least partially cover side surfaces 154 of radiator fins 124. The attachment mechanism could be as described in FIGS. 12-16, 18, 19a-19b, and 20a-20b.

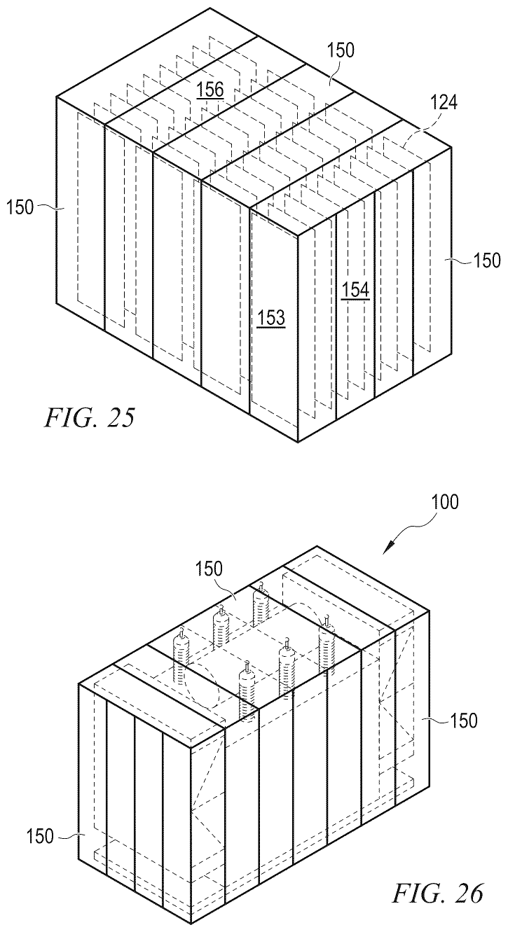

In FIG. 25, ballistic capes 150, each comprising a number of ballistic panels 140, can cover front surface 153 of radiator fins 124 using attachment mechanisms as described in FIGS. 12-16, 18, 19a-19b, and 20a-20b. In a similar manner, ballistic cape 150 can cover side surface 154 of radiator fins 124, as well as top surface 156 of the radiator fins.

In FIG. 26, ballistic capes 150, each comprising a number of ballistic panels 140, can cover an entirety of power transformer 100, including bushings 102 and 104, main structure 106, and cooling system 116 using attachment mechanisms as described in FIGS. 12-16, 18, 19a-19b, and 20a-20b.

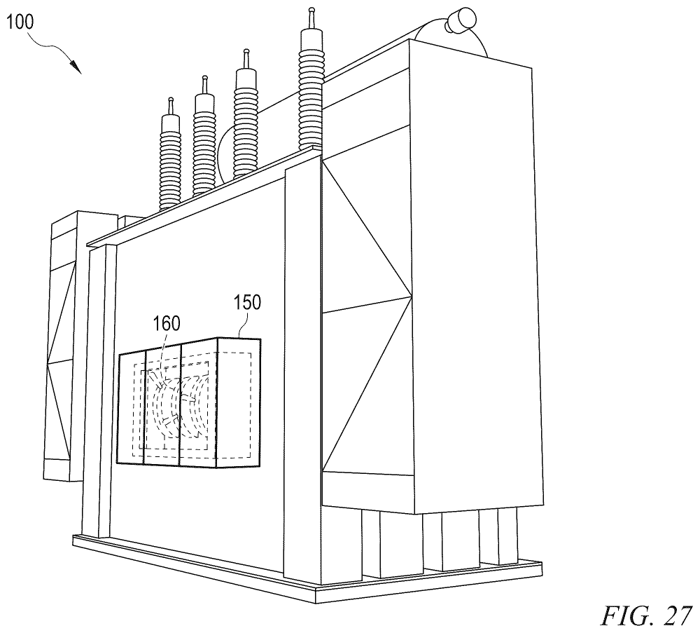

In FIG. 27, ballistic cape 150, comprising a number of ballistic panels 140, can cover load tap changers 160 using attachment mechanisms as described in FIGS. 12-16, 18, 19a-19b, and 20a-20b.

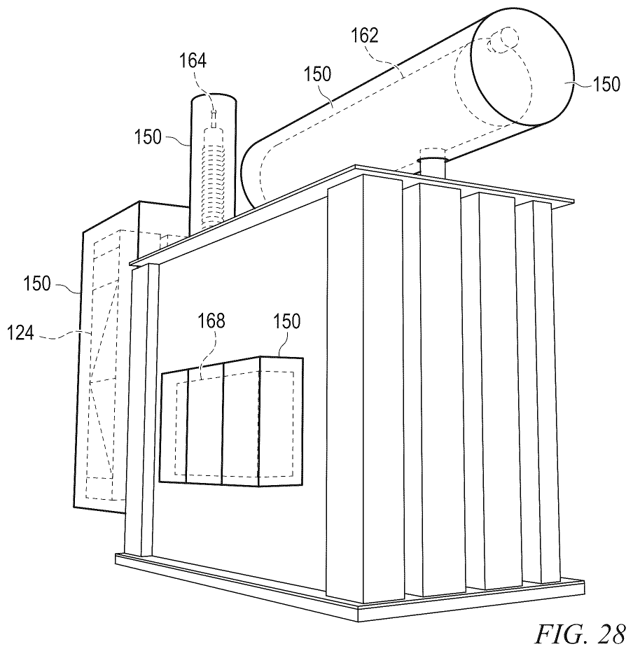

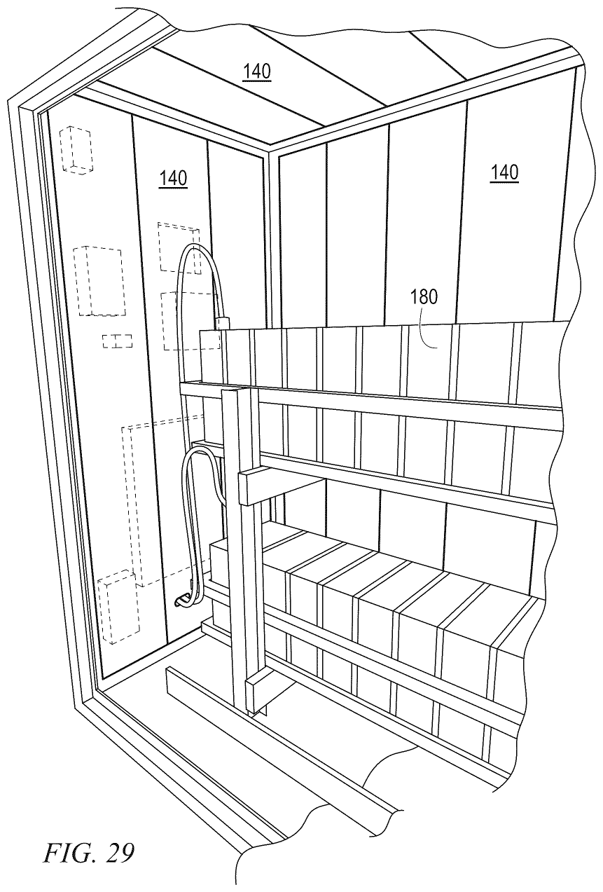

In FIG. 28, ballistic capes 150, each comprising a number of ballistic panels 140, can cover tank 162, bushings 164, and breaker boxes 168, as well as radiator fins 124 using attachment mechanisms as described in FIGS. 12-16, 18, 19a-19b, and 20a-20b.

In FIG. 29, ballistic panels 140 are positioned proximate to other vulnerable equipment, such as battery bank 180 using attachment mechanisms as described in FIGS. 12-16, 18, 19a-19b, and 20a-20b.

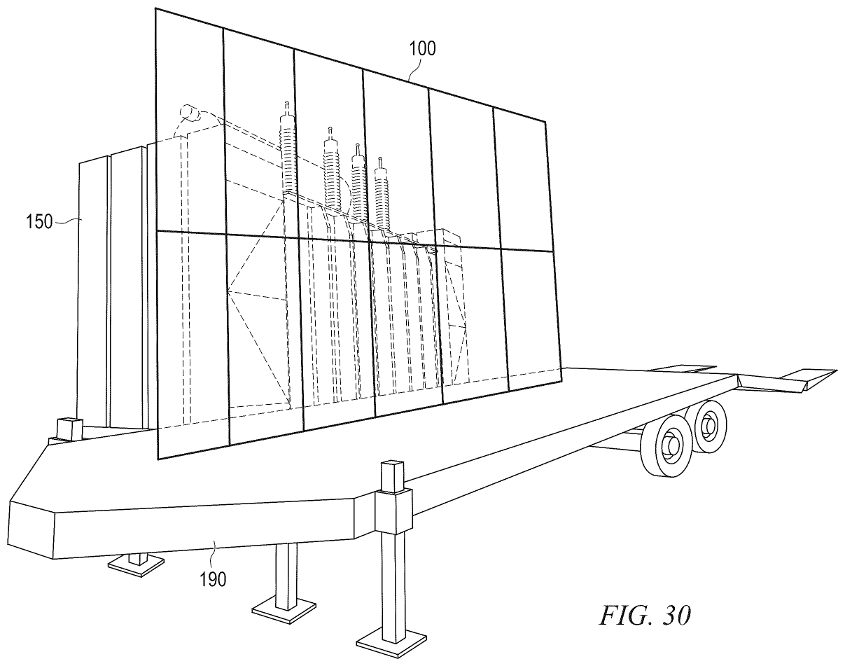

In FIG. 30, ballistic panels 140 are mounted to trailer 190. Ballistic panels 140 can be full-length or stacked, depending on height requirement. Trailer 190 is mobile and can be deployed and positioned in front of vulnerable assets in short notice of an immediate threat.

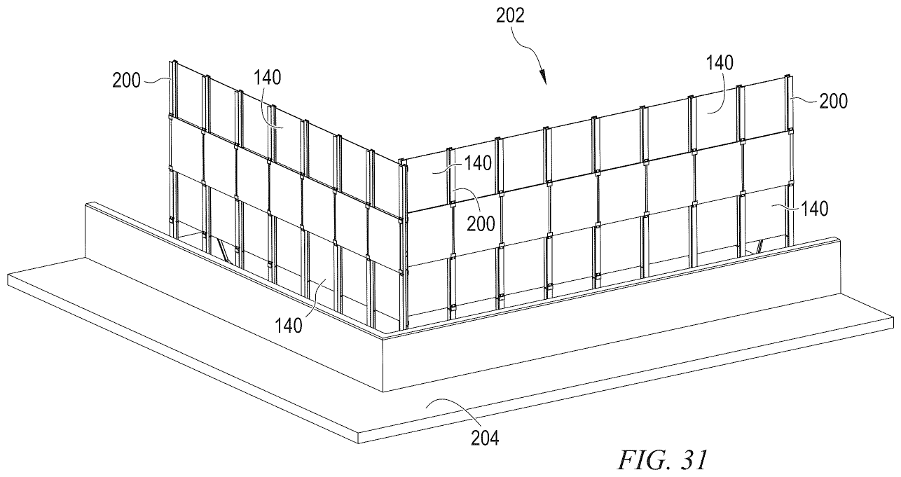

In another embodiment, ballistic panels 140 are attached to posts or beams 200 with screws, bolts, adhesive, or weld to form ballistic screen 202, as shown in FIG. 31. Posts 200 are set in foundation 204. Ballistic screen 202 provides a wider area of protection from external bullets, projectiles, and other ballistic threats.

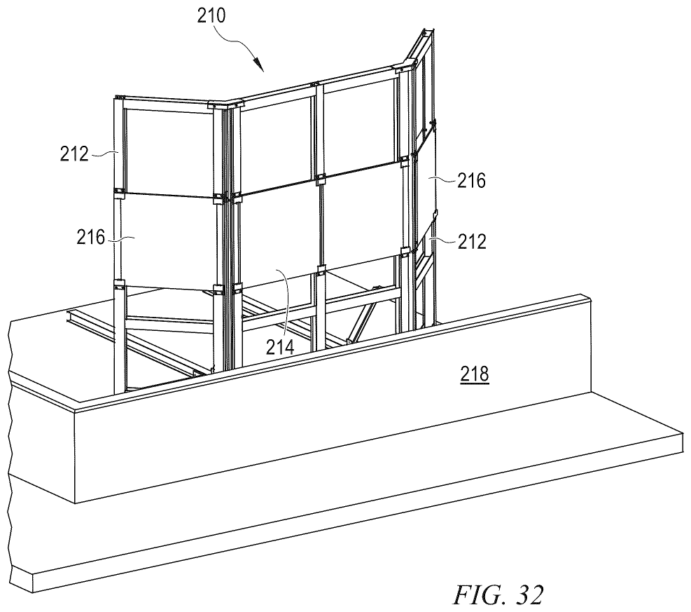

FIG. 32 shows ballistic screen 210 including ballistic panels 140 attached to posts or beams 212 with screws, bolts, adhesive, or weld. Posts 160 are set in foundation 218. Ballistic screen 210 has a front portion 214 and two angled side portions 216.

Ballistic panel 140 finds applications in and at critical infrastructure sites, including but not limited to electrical substations and power generation facilities. Ballistic panel 140 provides an effective means of protection against ballistic threats, ensuring the safety of personnel and critical assets behind the panel, such as electrical transformers, battery enclosures, radiators, bushings, load tap changers, tanks, breakers, and control rooms. The ballistic cape and array system comprises a unique combination of materials, chemical compounds, and structural elements, offering superior ballistic resistance while maintaining cost-effectiveness and ease of installation, care, and maintenance.

The novel design of the ballistic cape and array system offers numerous advantages over conventional ballistic protection systems. It provides enhanced protection against a wide range of ballistic threats while being lightweight and space-efficient. Additionally, the ballistic cape and array system can be customized to suit various applications, including critical infrastructure and associated assets such as electrical transformers, radiators, breakers, tanks, control rooms, and battery enclosures where ballistic protection is required.

While one or more embodiments have been illustrated and described in detail, the skilled artisan will appreciate that modifications and adaptations to those embodiments may be made without departing from the scope of the present disclosure.

What is claimed:

1. A ballistic panel, comprising:
a ballistic material; and
a fastening mechanism adapted to dispose the ballistic material with standoff over a surface of an asset.

2. The ballistic panel of claim 1, wherein the fastening mechanical includes:
a rail, wherein the rail is coupled to the asset;
a standoff coupled to the rail; and
a bracket coupled between the standoff and ballistic material.

3. The ballistic panel of claim 1, wherein the ballistic material includes a first layer and a second layer bonded to the first layer.

4. The ballistic panel of claim 3, wherein the first layer includes a material selected from the group consisting of polyethylene, aramid fiber, ballistic fabric, adhesives, ceramics, and aluminum oxide.

5. The ballistic panel of claim 3, wherein the second layer includes a material selected from the group consisting of steel, galvanized steel, iron, aluminum, and other metal having structural support for the first layer.

6. The ballistic panel of claim 1, wherein the asset includes a power transformer or other electric equipment.

7. A ballistic panel, comprising a ballistic material adapted to be disposed with standoff over a surface of an asset.

8. The ballistic panel of claim 7, further including a fastening mechanism adapted to dispose the ballistic material over the surface of the asset.

9. The ballistic panel of claim 8, wherein the fastening mechanical includes:
a rail, wherein the rail is coupled to the asset;
a standoff coupled to the rail; and
a bracket coupled between the standoff and ballistic material.

10. The ballistic panel of claim 7, wherein the ballistic material includes a first layer and a second layer bonded to the first layer.

11. The ballistic panel of claim 10, wherein the first layer includes a material selected from the group consisting of polyethylene, aramid fiber, ballistic fabric, adhesives, ceramics, and aluminum oxide.

12. The ballistic panel of claim 10, wherein the second layer includes a material selected from the group consisting of steel, galvanized steel, iron, aluminum, and other metal having structural support for the first layer.

13. The ballistic panel of claim 7, wherein the asset includes a power transformer or other electric equipment.

14. A method of making a ballistic panel, comprising:
forming a ballistic material; and
providing a fastening mechanism adapted to dispose the ballistic material with standoff over a surface of an asset.

15. The method of claim 14, wherein providing the fastening mechanical includes:
providing a rail;
coupling the rail to the asset;
coupling a standoff to the rail; and
coupling a bracket between the standoff and ballistic material.

16. The method of claim 14, wherein forming the ballistic material includes:
providing a first layer;
providing a second layer; and
bonding the second layer to the first layer.

17. The method of claim 16, wherein providing the first layer includes selecting a material from the group consisting of polyethylene, aramid fiber, ballistic fabric, adhesives, ceramics, and aluminum oxide.

18. The method of claim 16, wherein providing the second layer includes selecting a material from the group consisting of steel, galvanized steel, iron, aluminum, and other metal having structural support for the first layer.

19. The method of claim 14, wherein the asset includes a power transformer or other electric equipment.

20. The method of claim 14, further including providing a plurality of overlapping ballistic panels over the surface of the asset.
